(19) United States
(12) Patent Application Publication
(10) Pub. No.: US 2012/0208065 A1
(43) Pub. Date: Aug. 16, 2012

(54) Single Cell For a Battery

(75) Inventors: Dirk Schroeter, Winnenden (DE); Wolfgang Warthmann, Weinstadt (DE); Rainer Kaufmann, Stuttgart (DE); Jens Meintschel, Bernsdorf (DE); Claus-Rupert Hohenthanner, Hanau (DE); Claudia Brasse, Meerbusch (DE); Guenter Eichinger, Altenstadt (DE); Andreas Gutsch, Luedinghausen (DE); Michael Gnann, Deisenhofen (DE)

(73) Assignee: Daimler AG, Stuttgart (DE)

(21) Appl. No.: 13/387,909

(22) PCT Filed: Jul. 3, 2010
(86) PCT No.: PCT/EP2010/004049

§ 371 Date: Mar. 27, 2012

(30) Foreign Application Priority Data
Jul. 31, 2009 (DE) 10 2009 035 489.1

(51) Int. Cl. H01M 2/14; H01M 2/02; H01M 2/20

(52) U.S. Cl. 429/130

(57) ABSTRACT

A single cell for a battery that includes a first housing part and a second housing part, which are electrically isolated from one another by an insulating housing frame. An electrochemically-active material is located in housing frame between housing parts. The first housing part and second housing part are in the form of plates. At least one of the housing parts exhibits a first edge area bent over towards the inside, and first housing part and second housing part are fixed by a form fit to one-piece housing frame.

### BACKGROUND AND SUMMARY OF THE INVENTION

Exemplary embodiments of the invention relate to a single cell for a battery that includes a first housing part and a second housing part, which are electrically isolated from one another by means of an insulating housing frame, whereby an electrochemically active material is arranged between the housing parts in the housing frame.

PCT Publication No. WO 01 37353 A1 discloses a rechargeable, high-density energy provider in the form of a single cell for electronic devices. Here, the single cell comprises a first and a second metal cover, and a frame formed of plastic running round this cover. An edge area of the first and second cover respectively is bent over, whereby a corner area of the first and second cover respectively does not exhibit any bending over. The frame exhibits cutouts, by means of which the bent-over portions of the first and second cover correspond in a form fit. When the energy providers are put together, an adhesive agent is applied in the cut-out, by means of which the first and second cover can be fixed to the frame by means of a material bond.

German Patent document DE 20 2004 019 262 U1 discloses a superstructure for a protective housing of an accumulator battery. The protective housing comprises an upper and a lower cover, which are each formed of a metal plate. Within this arrangement, the upper and lower covers are connected by means of injection molding with a plastic part that forms a plastic edge. The accumulator battery is located between the upper and the lower cover, whereby the upper and the lower cover can be fixed to one another by ultrasound. The metal plate can be manufactured by stamping and the sides of the metal plates are formed as bent edges. These bent edges are provided with several clips on one surface, whereby one side of the clips is fixed to the bent edges. The clips are toothed in their respective orientation and the plastic part is fixed to these, in that the clips are embedded into the plastic edge during the injection molding process.

European Patent document EP 1 071 147 A1 describes an accumulator battery comprising a flat battery cell, whereby the battery cell exhibits a flat element generating electrical energy. For sealing of the element generating the electrical energy, at least one laminate film is applied as protective material. One positive and one negative pole are led out of the element generating the electrical energy. A printed circuit board is connected to the positive and the negative pole. Furthermore, a housing exhibiting two load-bearing side walls extending along two surfaces of the battery cell is provided. At least one of the load-bearing walls of the housing is at least in part formed of a metal.

Exemplary embodiments of the present invention are directed to a single cell of a battery in which lifetime is increased at high temperatures and mechanical stability of the single cell is improved.

The single cell for a battery, in particular a high-voltage battery, comprises a first housing part and a second housing part that are electrically isolated from one another by means of an isolating housing frame, whereby an electrochemically active material is arranged in the housing frame between the housing parts. According to the invention, the first housing part and the second housing part are in the form of plates, whereby at least one of the housing parts exhibits a first edge area bent over towards the inside and the first housing part and the second housing part are fixed by means of a form fit to the one-piece housing frame.

In useful fashion, the bent-over first edge area is formed on the first housing part. In this arrangement, the bent-over first edge of the first housing part acts in a beneficial fashion as a diffusion barrier and therefore prevents loss of electrolyte. In addition, the housing frame located between the housing parts, in particular its thickness, can be reduced, as at least the bent-over first edge of the first housing part acts in a stabilizing fashion. In this, the thickness of the housing frame means a distance between the first and the second housing part.

Furthermore, a heat dissipation function can be implemented by the bending over of at least the first edge area, as the bent-over first edge area of the first housing part can be orientated in the direction of a heat conducting plate, whereby heat generated in the single cell through charge and discharge can be fed to the heat conducting plate.

The bent-over first edge area of the first housing part can, in an advantageous embodiment, be bent over a plurality of times whereby a first section of the bent-over area, i.e. the first edge area, is bent over by at least 90°. A second section of the bent-over first edge area is bent over by at least 90° in relation to the first section and runs almost parallel to an inner surface side of the first housing part.

In a possible embodiment, the second section of the first edge area exhibits tooth-like shapes, which are, for example, arranged at regular intervals. This makes it possible to save material in advantageous fashion during manufacture of the first housing part.

The edge resulting from the bending over of at least the first edge area of the first housing part is thereby dimensioned in such a way that after putting together of the single cell, at least the first edge of the first housing part covers the housing frame except for a specified distance to the second housing part. In other words, the two housing parts enclose the inside of the cell and the housing frame surrounding the sides of the inside of the cell almost completely, with the exception of the remaining distance in the form of a slit. This means that both a width and also the thickness of the housing frame are reduced. In addition, the mechanical stability of the single cell is improved by means of the bent-over first edge area.

In addition, the manufacturing process of the single cell can be simplified, by inserting the housing frame into the first housing part by means of a molding process, preferably an injection molding process. In this connection, the housing frame can be molded onto the first housing part and/or injection molded into the first housing part.

Furthermore, a connecting element for a cell voltage monitoring unit can be arranged on the bent-over first edge area (on the side of the single cell), e.g., by means of a force and/or form fit.

In addition, the bent-over first edge area of the first housing part can advantageously close a filling opening for the electrochemically active material.

In a further possible embodiment of the single cell according to the invention, a second bent-over area is formed on the second housing part. For example, the second housing part exhibits a second bent-over edge area extending over one half of a longitudinal extension of the second housing part. Here, the bent-over second edge area is preferably formed on a long side of the second housing part.

In this arrangement, in order to achieve an efficient heat transfer from the individual cell to the heat conducting plate, the bent-over second edge area, which faces in the direction of the heat conducting plate, is bent over at an angle of for the most part precisely 90°.

In addition, the first and the second part are formed of a metal and therefore designed so as to have good heat conduction characteristics. Furthermore, such a metal housing part can form one pole of the single cell. For this, the housing part is connected with the electrochemically active material located in the interior of the cell in an electrically conductive manner. By these means, the housing parts of the single cell are designed to carry voltage.

The housing frame is preferably formed of a plastic material, in particular of a thermoplastic material, by means of which the first housing part and the second housing part are isolated from one another both electrically and spatially.

With regard to a cell array for a battery, the cell array includes a multiplicity, in particular a specified number, of single cells connected together electrically either in parallel or in series, which can be pressed together by means of pressure plates and tensioning bands.

The battery is particularly suitable for use as a vehicle battery, in particular as a high-voltage battery for a vehicle with hybrid drive or for a fuel cell vehicle.

### BRIEF DESCRIPTION OF THE DRAWING FIGURES

Embodiments of the invention will be explained in more detail based on drawings, which show the following:

FIG. 1 An exploded view of a single cell according to the invention, in schematic form,

FIG. 2 A perspective view of a first housing part and a second housing part of the single cell according to the invention,

FIG. 3 A perspective view of a single cell according to the invention in assembled state, in schematic form,

FIG. 4 A first housing part with bent-over edge area and a plate-shaped second housing part of the single cell according to the invention, in schematic form,

FIG. 5 A sectional view of an enlarged section of a single cell according to the invention according to FIGS. 1 to 4, where by an edge area of a first housing part is bent over once, in schematic form,

FIG. 6 A first housing part with edge area bent over a plurality of times, in schematic form,

FIG. 7 A first housing part with edge area bent over a plurality of times, whereby a second part of the bent-over section exhibits tooth-like shapes, in schematic form, and

FIG. 8 A sectional view of an enlarged portion of a single cell according to the invention in schematic form, whereby one edge area of a first housing part is bent over a plurality of times.

### DETAILED DESCRIPTION

Parts that correspond to one another are identified with the same numbers in the drawings.

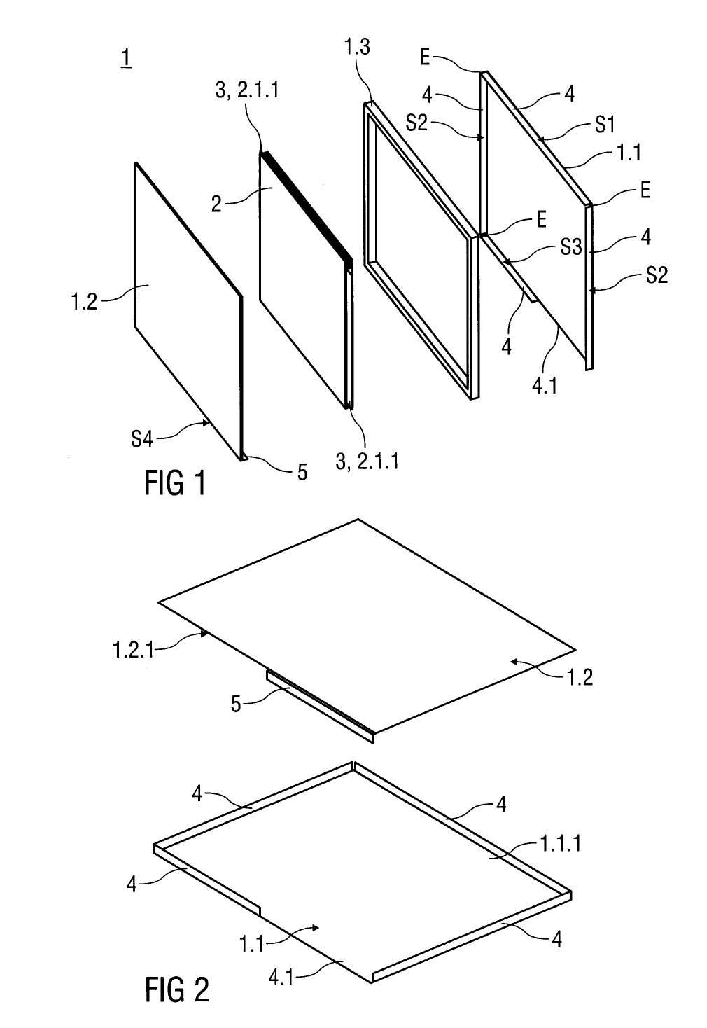

A possible embodiment of a single cell according to the invention, in particular a flat-cell frame, designated in the following text as flat-cell frame 1, is shown in FIGS. 1 to 4.

In detail, FIG. 1 shows an exploded view of flat-cell frame 1 according to the invention, whereby this is shown in a perspective view. In particular, a view of flat-cell frame 1 is shown from diagonally above the frame.

Flat-cell frame 1 is in particular a flat-cell frame for a battery, in particular a lithium-ion battery, whereby the battery is in particular a vehicle battery for a vehicle with hybrid drive or a fuel cell vehicle.

For this purpose, a cell array is located in the battery, which is not described or shown in more detail here. This array exhibits a multiplicity, i.e. a specifiable number of flat-cell frames 1 which are connected in series or in parallel to one another.

Flat-cell frame 1 in accordance with the invention includes a first housing part 1.1, a second housing part 1.2 and a one-piece housing frame 1.3. Housing parts 1.1, 1.2 are both electrically and spatially isolated from one another by means of housing frame 1.3. Housing frame 1.3 is formed of a thermoplastic material, whereas housing parts 1.1, 1.2 are implemented in metal.

An electrochemically active material is present in housing frame 1.3 between housing parts 1.1, 1.2, for example in the form of an electrode film stack 2, whereby electrode film stack 2 is formed of electrode films 2.1, as shown in more detail in FIG. 5.

In this arrangement, electrode films 2.1 are connected in an electrically conductive fashion with a pole 3 by means of their current output lugs 2.1.1, for example by means of welding. Furthermore, these current output lugs 2.1.1, are drawn together as pole 3 of one polarity and are connected with the respective metal housing parts 1.1, 1.2 of a corresponding polarity, which means that housing parts 1.1, 1.2 are implemented so as to carry voltage.

According to the invention, first housing part 1.1 and second housing part 1.2 are implemented in the form of plates, whereby at least one of housing parts 1.1 exhibits a first edge area 4 bent towards the inside, i.e., in the direction of the interior of the cell, and first housing part 1.1 and second housing part 1.2 are fixed to one-piece housing frame 1.3 by means of a form fit.

In the present embodiment according to FIG. 1, first edge area 4 is formed onto first housing part 1.1. In this arrangement, first edge area 4 is bent over to the inside at a first long side S1, at opposite sides S2 and at a second long side S3 extending over half a length of second long side S3.

Within this, first edge area 4 is bent over once, whereby first edge area 4 is bent over in particular at the first long side S1 and the two short sides S2 by at least 90°.

For example, first housing part 1.1 is manufactured by means of stamping out, whereby stamped first housing part 1.1 particularly advantageously exhibits a contour such that first edge area 4 of first housing part 1.1 can be bent over simply and without great expenditure of time or cost. In particular, bent-over first edge area 4 is formed in such a way that it is split in corner areas E corresponding to sides S1 to S3 of first housing part 1, by which means edge area 4 is divided into different sides.

Bent-over first edge area 4 of second long side S3 is preferably bent over precisely by 90°, as second long side S3 can be located so as to face towards a heat conducting plate, not described in more detail here, when flat-cell frame 1 is used in a battery. In this arrangement, heat generated in flat-cell frame 1 during charging and discharging can be fed to the heat conducting plate. The heat conducting plate preferably exhibits a channel structure through which a cooling medium and/or a refrigerant flows, enabling the heat conducted to the heat conducting plate to be dissipated. This means that heat transfer is supported by bent-over first edge area 4.

Corresponding to the bending over of first edge area 4 of first housing part 1.1, a second edge area 5 is bent over on second housing part 1.2, which is of mainly plate-shaped design. In this arrangement, second bent-over edge area 5 extends over one half of a length of a lower long side S4 of second housing part 1.2.

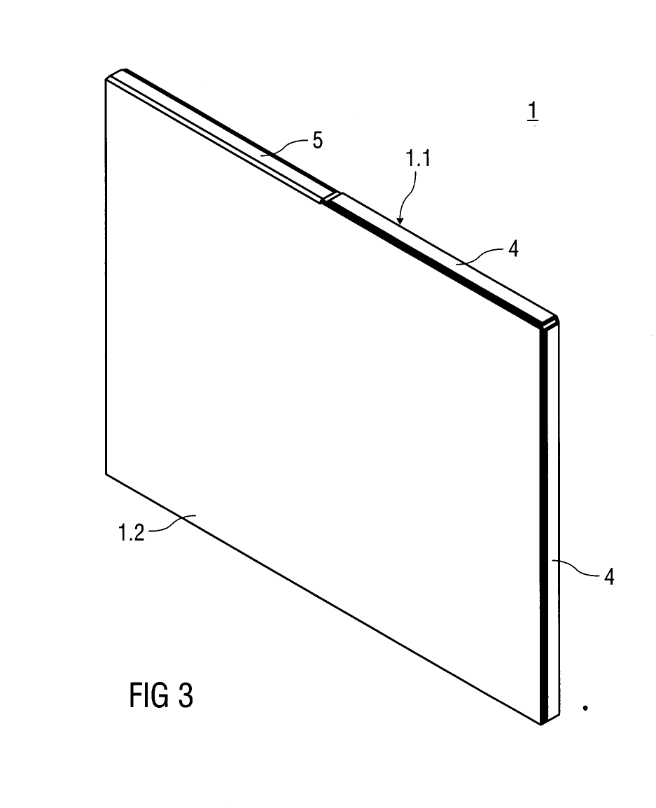

Second bent-over edge area 5 is thereby arranged on plate-shaped housing part 1.2 in such a way that bent-over second edge area 5 replaces a missing bent-over edge area 4.1 of first housing part 1.1 when flat-cell frame 1 is put together, as is shown in more detail in FIGS. 2 and 3. By these means, a complete housing of flat-cell frame 1 is manufactured in a particularly advantageous manner, as shown in FIGS. 2 and 3. Depending on the specification, bent-over edge areas 4 and 5 can be provided alternately.

In this, the bending-over of first edge area 4 or first housing part 1.1 and bent-over second edge area 5 of second housing part 1.2 can be arranged parallel to the heat conducting plate, as described above, if flat-frame cell 1 is used in a battery.

Because first edge area 4 is bent over in particular on second long side S3 of first housing part 1.1 and second edge area 5 of second housing part 1.2, it is possible to achieve more efficient and even cooling of flat-cell frame 1 by means of the heat conducting plate. In this, the heat generated in flat-cell frame 1 can be dissipated via housing parts 1.1, 1.2, in particular via a purely metallic heat conductive path, at the heat conducting plate.

In the manufacturing of flat-cell frame 1, it is possible in a particularly advantageous manner to mould housing frame 1.3, for example, onto second housing part 1.2 by means of injection molding, or to circumferentially mould-in the bent-over first edge area 4 in first housing part 1.1. For this purpose, one angle of the angle of bending of first edge area 4 on first long side S1 and the two opposing short sides S2 of first housing part 1.1 can be selected so as to be greater than 90°, by which means bent-over first edge area 4 of corresponding sides S1, S2 is embedded in housing frame 1.3 following the injection molding procedure. By these means housing frame 1.3 is advantageously fixed by means of a form fit at least to first housing part 1.1.

If, during manufacture of flat-cell frame 1, housing frame 1.3 is molded into first housing part 1.1 circumferentially around bent-over first edge area 4, second housing part 1.2 is subsequently fixed to housing frame 1.3 in a hot press process.

First and second housing parts 1.1, 1.2 of flat-cell frame 1 are shown in a perspective view in FIG. 2, which illustrates that dimensions of an inner first surface side 1.1.1 of first housing part 1.1 correspond to dimensions of an inner second surface side 1.2.1 of second housing part 1.2.

FIG. 3 shows the flat-cell frame 1 depicted in FIG. 1 in assembled state.

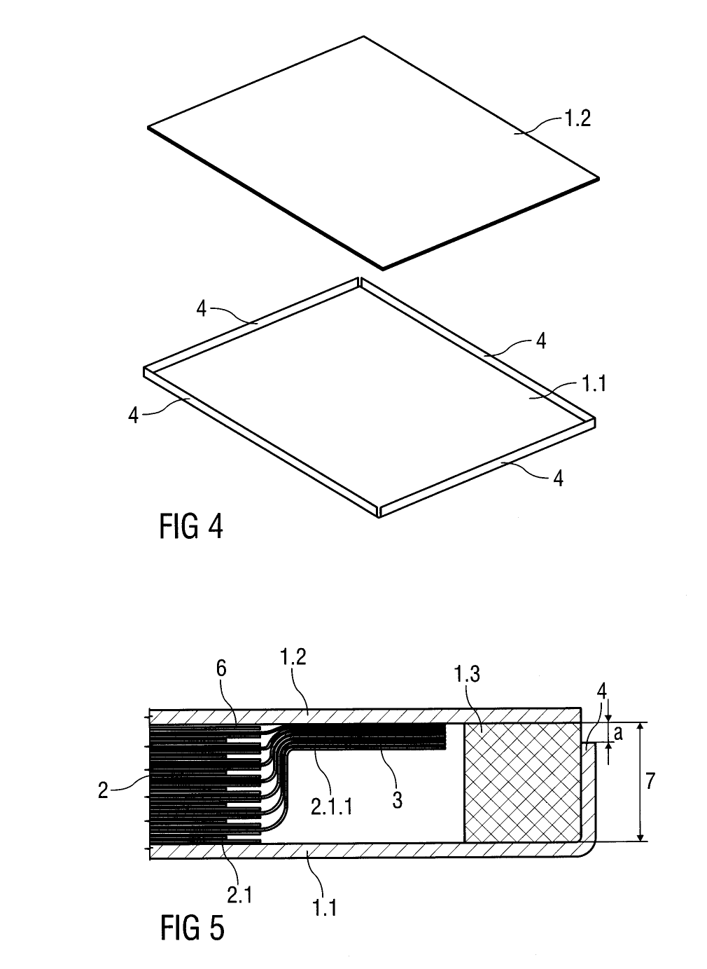

FIG. 4 shows an exploded view of a second possible embodiment of housing parts 1.1, 1.2 of the flat-cell frame according to the invention.

In this, first edge area 4 of first housing part 1.1 is completely bent over towards the inside, whereby second housing part 1.2 is in the form of a plate and in particular in the form of a rectangle.

In particular, the long first side S1 or long second side S3 facing towards the heat conducting plate is led up to the heat conducting plate and is bent over parallel to it, in particular by 90°, in order to ensure heat transfer from flat-cell frame 1, in particular via bent-over first edge area 4 to the heat conducting plate.

In the manufacture of flat-cell frame 1 in accordance with the present embodiment, housing frame 1.3 is molded onto plate-shaped housing part 1.2, for example by means of injection molding. Alternatively, housing frame 1.3 is molded into first housing part 1.1 by means of injection molding, circumferentially round edge area 4 which is bent over towards the inside.

FIG. 5 shows a sectional view of an enlarged section of flat-cell frame 1 in accordance with FIGS. 1 to 4. In detail, FIG. 5 shows electrode film stack 2 located in the inside of the cell. In this arrangement, ends of electrode films 2.1 of the same polarity, the so-called current output lugs 2.1.1, are connected together into a pole 3. In particular, pole 3 that is shown is connected in electrically conductive fashion with second housing part 1.2, by means of which at least second housing part 1.2 is formed so as to carry voltage.

Separators 6 are located between the individual electrode films 2.1 of electrode film stack 2, whereby electrode films 2.1 are electrically isolated from one another.

In the present embodiment, first edge area 4 of first housing part 1.1 is bent over towards the inside. In this arrangement, bent-over first edge area 4 is dimensioned in such a way, in particular its thickness 7 is dimensioned in such a way, that the latter encloses housing frame 1.3 of flat-cell frame 1 except for a specifiable distance “a” to the mostly plate-shaped second housing part 1.2. In other words, the two housing parts 1.1, 1.2 enclose the interior of the cell and housing frame 1.3 which surrounds the interior of the cell at the sides almost completely, with the exception of the remaining specifiable distance a in the form of a gap. By these means, both a width and also the thickness of housing frame 1.3 can be reduced. In this connection, the thickness of housing frame 1.3 means the distance between housing parts 1.1, 1.2.

In addition, mechanical stability of flat-cell frame 1 is advantageously improved at least by means of bent-over first edge area 4.

Because housing parts 1.1, 1.2 are fixed to one-piece housing frame 1.3 by means of a form fit, and housing parts 1.1, 1.2 form an almost closed metal casing of flat-cell frame 1, also in the area of the housing frame, a diffusion barrier is realized in a particularly advantageous fashion, by means of which loss of electrolyte from flat-cell frame 1—even over a longer period of time—is prevented.

By making use of the bent-over first edge areas 4 of first housing part 1.1, it is possible to locate a connecting element on first edge area 4, for example to press it on, in order to be able to tap voltage/current for cell monitoring and/or to tap a so-called balancer at corresponding flat-cell frame 1.

In addition, it is possible to close an electrolyte filling opening provided on the side of housing frame 1,3 for example by means of first edge area (4), as housing parts 1.1, 1.2 are fixed to housing frame 1.3 by means of a form fit using a hot press process.

Advantageously, the stamped and/or cut out first housing part 1.1 is simply folded, in other words bent over, which means that manufacturing costs and costs for jigs and fixtures for manufacturing flat-cell frame 1 can be reduced. The available space in corner areas E of flat-cell frame 1 is utilized in optimum fashion, as flat-cell frame 1 can be implemented with sharp edges, without taking tool radii or the flow behavior of a material used for manufacture of housing parts 1.1, 1.2 into consideration.

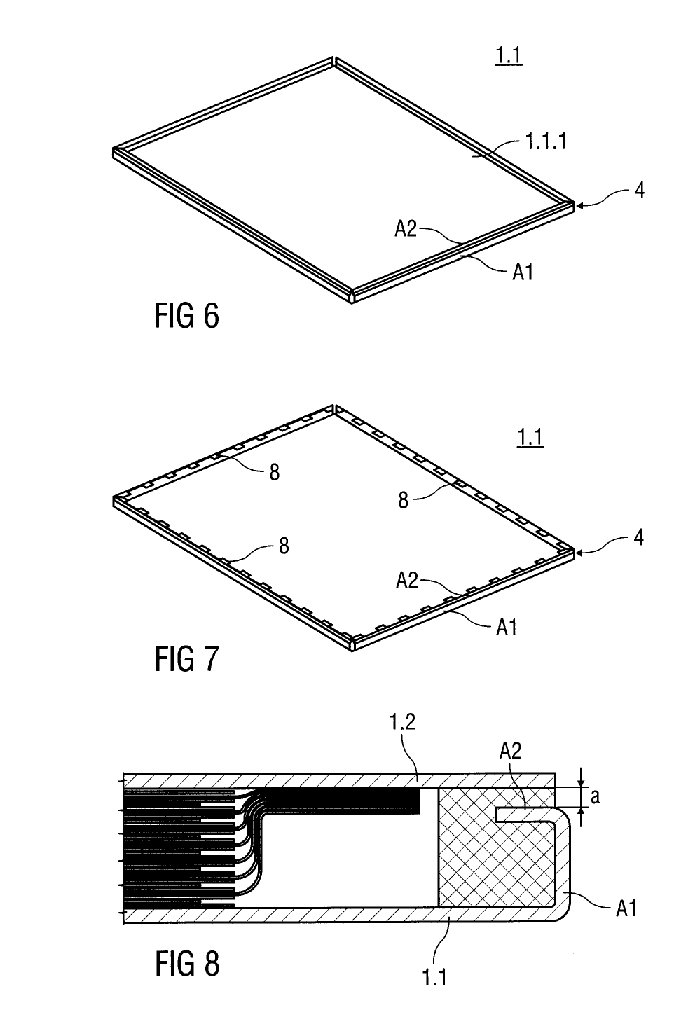

FIG. 6 shows first housing part 1.1 in a further possible embodiment, in particular a further possible embodiment of bent-over first edge area 4. In this case, bent-over first edge 4 is bent over a plurality of times, in particular twice.

A first section A1 of the bending is for example bent over by 90° towards the inside, whereby a second section A2 of the bending of first edge area 4 is bent over in such a way that it runs almost parallel to inner surface side 1.1.1 of first housing part 1.1.

During manufacture of flat-cell frame 1 with edge area 4 of first housing part 1.1 bent over a plurality of times, housing frame 1.3 is preferably molded-in onto first edge area 4 by means of injection molding in such a way that second section A2 of the bending is inserted into housing frame 1.3 and clipped together with housing frame 1.3, as shown in FIG. 8 in a sectional view.

FIG. 7 shows first housing part 1.1, also with a first edge area 4 bent over a plurality of times. In particular, second section A2 of the bending is provided with tooth-like shapes 8 and therefore implemented so as to resemble a crown. In this, tooth-like shapes 8 are arranged at regular intervals, in particular at least as regards a respective side S1 to S3 of the first housing part 1.1. As tooth-like shapes 8 are preferably embedded in housing frame 1.3 when the latter is molded-in, by means of which the form-fit fixing of first housing part 1.1 to housing frame 1.3 is improved.

FIG. 8 shows a sectional view of an enlarged section of flat-cell frame 1 according to FIGS. 6 and 7.

In particular it is shown that first section A1 of the multiple bending over of first edge area 4 is dimensioned in such a way that first section A1 of bent-over first edge area 4 also encloses housing frame 1.3 of flat-cell frame 1 with the exception of the specifiable distance a to the mostly plate-shaped second housing part 1.2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMBERS

1 Flat-cell frame
1.1 First housing part
1.1.1 Inner first surface side
1.2 Second housing part
1.2.1 Inner second surface side
1.3 Housing frame
2 Electrode film stack
2.1 Electrode film
2.1.1 Current output lug
3 Pole
4 First edge area
4.1 Missing edge area
5 Second edge area
6 Separator
7 Thickness
E Corner area
A1 First section
A2 Second section
S1 First long side
S2 Short side
S3 Second long side
S4 Lower long side
a specifiable distance

1-15. (canceled)

16. A single cell for a battery, comprising:
a first housing part;
a second housing part;
an insulating housing frame configured to electrically isolate the first and second housing parts from one another, wherein an electrochemically active material is located in insulating housing frame between the first and second housing parts,
wherein the first housing and second housing parts are in the form of plates, at least one of the first and second housing parts includes a first edge area bent over towards an inside, and the first and second housing parts are fixed by a form fit to the insulating housing frame, which is a one-piece housing frame.

17. The single cell according to claim 16, wherein the first housing part includes the first edge area, which is bent over a plurality of times.

18. The single cell according to claim 17, wherein a first section of the bending of first edge area is bent over by at least 90°.

19. The single cell according to claim 18, wherein a second section of the bending of first edge area is bent over by at least 90° in relation to first section.

20. The single cell according to claim 19, wherein the second section of first edge area includes tooth-like shapes or forms a crown-like edge.

21. The single cell according to claim 20, wherein the tooth-like shapes are arranged at regular intervals.

22. The single cell according to claim 16, wherein a thickness of the first edge area is dimensioned in such a way that following assembly of the single cell, the first housing part covers the insulating housing frame except for a specifiable distance.

23. The single cell according to claim 22, wherein a first section of first edge area covers the insulating housing frame except for a specifiable distance.

24. The single cell according to claim 16, wherein the second housing part includes a second edge area, wherein the second edge area extends over a half of a longitudinal extension of the second housing part and is bent over at least once.

25. The single cell according to claim 24, wherein a lower long side of the bent-over second edge area faces towards a heat conducting plate.

26. The single cell according to claim 24, wherein the bent-over second edge area is angled over at 90°.

27. The single cell according to claim 16, wherein the first and second housing parts are metal.

28. The single cell according to claim 16, wherein the insulating housing frame is composed of a plastic material.

29. A cell array, comprising:
a multiplicity of single cells, each of which includes
a first housing part;
a second housing part;
an insulating housing frame configured to electrically isolate the first and second housing parts from one another, wherein an electrochemically active material is located in insulating housing frame between the first and second housing parts,
wherein the first housing and second housing parts are in the form of plates, at least one of the first and second housing parts includes a first edge area bent over towards an inside, and the first and second housing parts are fixed by a form fit to the insulating housing frame, which is a one-piece housing frame,
wherein the multiplicity of single cells are electrically connected together electrically in parallel or in series.

30. The cell array of claim 29, wherein the cell array are part of a vehicle battery for a vehicle with hybrid drive or a fuel cell vehicle.
